(19) United States
(12) Patent Application Publication
(10) Pub. No.: US 2024/0282283 A1
(43) Pub. Date: Aug. 22, 2024

(54) TERMINAL APPARATUS, CONTROL METHOD FOR SYSTEM, AND NON-TRANSITORY COMPUTER READABLE MEDIUM

(71) Applicant: TOYOTA JIDOSHA KABUSHIKI KAISHA, Toyota-shi (JP)

(72) Inventors: Kyohei KITAZAWA, Kawasaki-shi (JP); Jun IKARASHI, Shinagawa-ku (JP); Akihito IKARASHI, Sumida-ku (JP); Nobutoshi SUWA, Taito-ku (JP); Daisuke KIKUCHI, Yokohama-shi (JP)

(73) Assignee: TOYOTA JIDOSHA KABUSHIKI KAISHA, Toyota-shi (JP)

(21) Appl. No.: 18/420,259

(22) Filed: Jan. 23, 2024

(30) Foreign Application Priority Data
Feb. 17, 2023 (JP) 2023-023826

(51) Int. Cl. G10H 1/00

(52) U.S. Cl. CPC G10H 1/0008; G10H 2220/056

(57) ABSTRACT

A terminal apparatus includes an imager configured to capture an image of a first user, a controller configured to generate an image to be displayed on a display, and a communication interface configured to communicate with a separate terminal apparatus used by a second user, and the controller is configured to transmit a first captured image of the first user to the separate terminal apparatus via the communication interface and generate a composite image that includes the first user and the second user and in which a line of sight of the second user is directed to a position of the first user in order to display the composite image on the display based on the first captured image, a second captured image of the second user, and a display position of the display.

### CROSS-REFERENCE TO RELATED APPLICATION

This application claims priority to Japanese Patent Application No. 2023-023826 filed on Feb. 17, 2023, the entire contents of which are incorporated herein by reference.

### TECHNICAL FIELD

The present disclosure relates to a terminal apparatus, a control method for a system, and a non-transitory computer readable medium.

### BACKGROUND

Technology related to playing a remote duet on a musical instrument is known. For example, Patent Literature (PTL) 1 discloses a musical instrument and a musical instrument system in which a display showing the hands placed on the other player's keyboard is arranged in front of a keyboard.

### CITATION LIST

### Patent Literature

PTL 1: JP 2006-078863 A

### SUMMARY

There is room to improve the realistic feel of playing remote duets.

It would be helpful to enable an improvement in the realistic feel of playing remote duets on musical instruments.

A terminal apparatus according to an embodiment of the present disclosure includes:
an imager configured to capture an image of a first user;
a controller configured to generate an image to be displayed on a display; and
a communication interface configured to communicate with a separate terminal apparatus used by a second user,
wherein the controller is configured to:
   transmit a first captured image of the first user to the separate
   generate a composite image that includes the first user and the second user and in which a line of sight of the second user is directed to a position of the first user in order to display the composite image on the display based on the first captured image, a second captured image of the second user, and a display position of the display.

According to an embodiment of the present disclosure, it is possible to improve the realistic feel of playing remote duets on musical instruments.

### BRIEF DESCRIPTION OF THE DRAWINGS

In the accompanying drawings:

FIG. 1 is a block diagram illustrating an example configuration of a system according to an embodiment of the present disclosure;

FIG. 2 is a diagram illustrating an example use of the system; and

FIG. 3 is a flowchart illustrating example operations of a terminal apparatus.

### DETAILED DESCRIPTION

Hereinafter, an embodiment of the present disclosure will be described with reference to the drawings.

### Outline of Embodiment

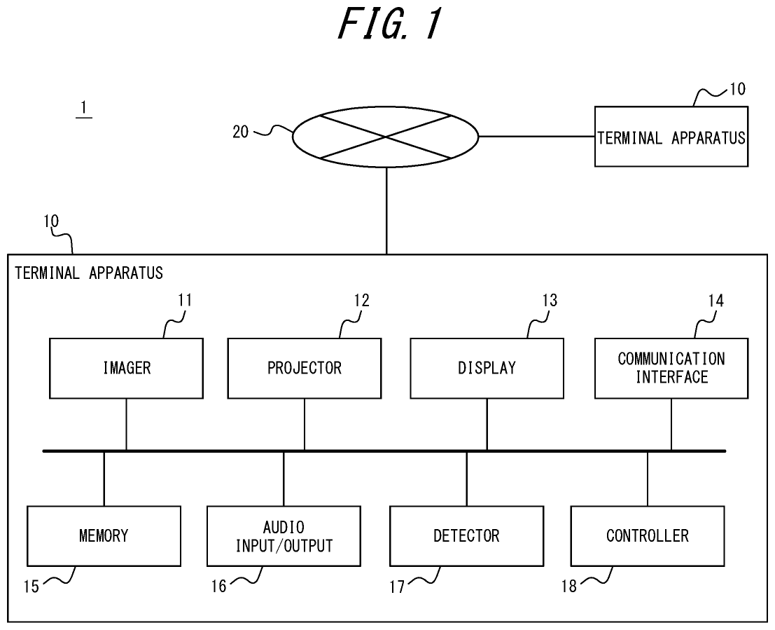

An example configuration of a system 1 according to an embodiment of the present disclosure will be described with reference to FIG. 1. The system 1 includes at least one pair of terminal apparatuses 10. The terminal apparatuses 10 are communicably connected to each other via a network 20 including, for example, the Internet, a mobile communication network, and the like. The terminal apparatuses 10 transmit and receive information on playing a duet on a musical instrument to and from each other. Users of the terminal apparatuses 10 play a duet on musical instruments (hereinafter also referred to as “playing a remote duet”) via the network 20 using the terminal 30 apparatuses 10. In other words, the users in the present embodiment are players of musical instruments. The terminal apparatuses 10 may, for example, communicate information via a server connected to the network 20. Such a server belongs to, for example, a cloud computing system or other computing system and implements various functions. The number of terminal apparatuses 35 10 included in the system 1 is 2 in the present embodiment, but is not limited to this and may be freely determined, for example, according to the number of players who play a duet, a trio, a quartet, or the like.

First, a terminal apparatus 10 of the present embodiment includes an imager 11 configured to capture an image of a first player of a musical instrument and a controller 18 configured to generate an image to be displayed on a display 13. The terminal apparatus 10 further includes a communication interface 14 configured to communicate with a separate terminal apparatus 10 used by a second player. The controller 18 of the terminal apparatus 10 transmits a first captured image of the first player to the separate terminal apparatus 10 via the communication interface 14, and further generates a 10 composite image that includes the first player and the second player and in which the line of sight of the second player is directed to the position of the first player in order to display the composite image on the display 13 based on the first captured image of the first player, a second captured image of the second player, and a display position of the display.

Thus, according to the present embodiment, the composite image that

includes the first player and the second player and in which the line of sight of the second player is directed to the position of the first player is generated. This enables the first player to have an experience through the composite image as if the first player were making eye contact over a mirror with the other player playing next to the first player by displaying the composite image on the display 13 of the terminal apparatus 10 while the first player is playing, for example. As a result, it is easier to improve the realistic feel of playing a duet.

Next, configurations of the system 1 will be described in detail.

### Configuration of Terminal Apparatus

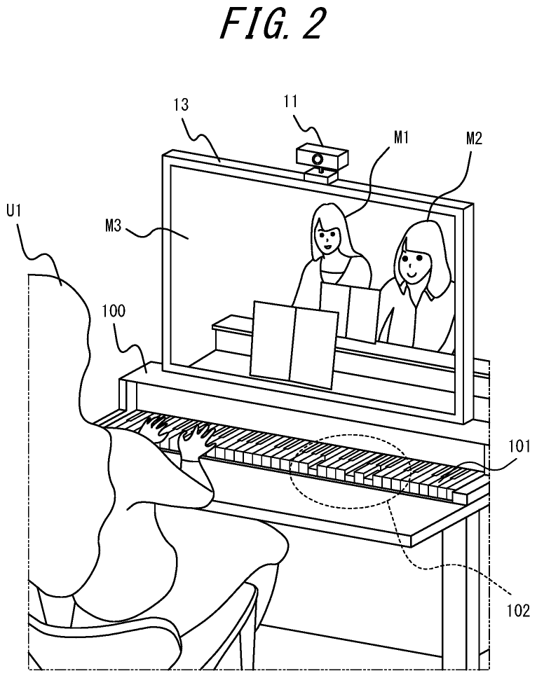

As illustrated in FIG. 2, the terminal apparatus 10 includes the imager 11, a projector 12, the display 13, the communication interface 14, a memory 15, an audio input/output 16, a detector 17, and the controller 18.

The imager 11 includes a camera that captures an image of a subject using visible light and a distance measuring sensor that measures the distance to the subject to acquire a distance image. The camera captures the subject at, for example, 30 frames per second to produce a moving image formed by a series of captured images. The distance measuring sensor includes a Time of Flight (ToF) camera, a Light Detection And Ranging (LiDAR) sensor, or a stereo camera and generates a distance image of the subject including distance information. The distance measuring sensor can acquire information on the position of the subject captured by the imager 11 (spatial coordinates, etc.), a relative position of the subject with respect to the display 13, and the like. The imager 11 transmits the captured image and the distance image to the controller 18. In an embodiment, the terminal apparatus 10 captures an image of a first player of a musical instrument who uses the terminal apparatus 10 using the imager 11 to acquire a captured image of the first player. For example, the controller 18 can acquire information on the position of the pupils, the gazing point, the line of sight, and the like of the subject by image analysis of the acquired captured image.

The projector 12 may be of any type of the projector, such as a liquid crystal display (LCD) projector, a liquid crystal on silicon (LCOS) projector, or a digital light processing (DLP) projector. The projector 12 includes an image display element, a light source, and a projection lens. For example, as the image display element, a liquid crystal is used in the case of an LCD or LCOS projector, and a Digital Micromirror Device (DMD) is used in the case of a DLP projector. The light source irradiates projection light onto the image display element and projects an image onto a projection surface through the projector 12. The light source can also irradiate illumination light in addition to the projection light. The irradiation range of the projection light and the irradiation range of the illumination light may be the same or different. The projection lens displays the image of the image display element on the projection surface while magnifying or reducing the image at any magnification. In an embodiment, the terminal apparatus 10 uses the projector 12 to project an image onto the musical instrument played by the first player who uses the terminal apparatus 10.

The display 13 is positioned at any location that is easily visible to the first user of the terminal apparatus 10. The display 13 is, for example, an LCD or an organic electro luminescent (EL) display. The display 13 displays data acquired by the operations of the terminal apparatus 10, for example, an image acquired by the imager 11. The display 13 may be connected to the terminal apparatus 10 as an external output device, instead of being included in the terminal apparatus 10. As an interface for connection, for example, an interface compliant with a standard such as Universal Serial Bus (USB) or Bluetooth® (Bluetooth is a registered trademark in Japan, other countries, or both) can be used. The display 13 can be positioned at any location that is easily visible to the first user of the terminal apparatus 10. In an embodiment, the terminal apparatus 10 displays the captured image of the first player of the musical instrument and the composite image generated based on the captured image on the display 13.

The communication interface 14 includes at least one interface for communication. The interface for communication includes an interface compliant with a wired or wireless LAN standard, an interface compliant with a mobile communication standard such as Long Term Evolution (LTE), 4th Generation (4G), or 5th Generation (5G), or the like. The communication interface 14 receives information to be used for the operations of the terminal apparatus 10 and transmits information acquired by the operations of the terminal apparatus 10. The terminal apparatus 10 connects to the network 20 via a nearby router apparatus or mobile communication base station using the communication interface 14 and communicates with an external apparatus such as the separate terminal apparatus 10 via the network 20. In an embodiment, the terminal apparatus 10 communicates with the separate terminal apparatus 10 used by the second player using the communication interface 14.

The memory 15 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 15 stores information to be used for the operations of the terminal apparatus 10 and information acquired by the operations of the terminal apparatus 10.

The audio input/output 16 has a microphone that accepts acoustic input and audio input and a speaker. In an embodiment, the audio input/output 16 provides an audio interface between the first player of the musical instrument and the terminal apparatus 10. The audio input/output 16 receives audio data from the musical instrument played by the first player, converts the audio data into electrical signals, and transmits the electrical signals to the speaker. The speaker converts the electrical signals into human audible sound waves. The audio input/output 16 may include a headset jack. The headset jack provides an interface to/from removable audio input/output peripherals such as headsets with headphones and/or microphones.

The detector 17 has any sensor module, including an eye tracking camera capable of acquiring data on human eye movements. The detector 17 transmits information indicating the result of detection by the sensor module to the controller 18. The sensor module includes, for example, a laser sensor, a photoelectric sensor, an ultrasonic sensor, a near-infrared LED (Infrared Emitting Diode), or a combination of these. However, the detector 17 is not limited to these examples and may have any other sensor module that detects the state or the operations of each component of the terminal apparatus 10, or an interface with each sensor module. The detector 17 transmits information indicating the result of detection by the sensor module to the controller 18. In an embodiment, in addition to or instead of the image analysis of the captured image acquired using the imager 11 described above, the controller 18 can acquire information on the position of the pupils, the gazing point, the line of sight, or the like of the subject by processing the data information transmitted from the detector 17.

The controller 18 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 18 controls the operations of the entire terminal apparatus 10. In an embodiment, the terminal apparatus 10 generates the image to be displayed on the display 13 using the controller 18.

The functions of the terminal apparatus 10 are realized by a processor included in the controller 18 executing a control program. The control program is a program for causing a computer to function as the terminal apparatus 10. Some or all of the functions of the terminal apparatus 10 may be realized by a dedicated circuit included in the controller 18. The control program may be stored on a non-transitory recording or storage medium readable by the terminal apparatus 10 and be read from the medium by the terminal apparatus 10.

FIG. 2 is a diagram illustrating an example use of the system 1. As illustrated in FIG. 2, the system 1 is used for playing a remote duet on a musical instrument 100. In the example illustrated in FIG. 2, the musical instrument 100 is a plano equipped with a keyboard 101. However, the musical instrument 100 is not limited to a plano, and may be any musical instrument, including another type of keyboard instrument (such as an organ) or a percussion instrument (such as a drum), such that one musical instrument is played jointly by the first player and the second player. The musical instrument 100 may be an electronic musical instrument that produces electronic sounds. FIG. 2 illustrates a situation on the side of the first player (hereinafter also referred to as “player U1”) of the musical instrument 100 who uses the terminal apparatus 10 in a case in which the player U1 and the second player (hereinafter also referred to as “player U2”) of another musical instrument 100 who uses the separate terminal apparatus 10 play a remote duet using their respective terminal apparatuses 10. In the following, in order to distinguish between the terminal apparatus 10 and musical instrument 100 on the player U1 side, and the terminal apparatus 10 and musical instrument 100 on the player U2 side, they are also referred to as a terminal apparatus 10A and musical instrument 100A, and a terminal apparatus 10B and musical instrument 100B, respectively, for convenience. In accordance with this, the components of each terminal apparatus are also distinguished by adding a “A” or “B” branch number to the reference code as necessary.

On the player U1 side, a figure of the player U1 who plays the musical instrument 100A is captured by the camera of the imager 11A on the terminal apparatus 10A side. The captured image (hereinafter also referred to as a “first captured image”) is transmitted to the terminal apparatus 10B of the player U2 via the network 20. At the same time, on the player U2 side, a figure of the player U2 who plays the musical instrument 100B is captured by the camera of the imager 11B on the terminal apparatus 10B side. The captured image (hereinafter also referred to as a “second captured image”) is transmitted to the terminal apparatus 10A of the player U1 via the network 20.

Then, the controller 18A of the terminal apparatus 10A generates a composite image M3 that includes the player U1 and the player U2, and in which the line of sight of the player U2 is directed to the position of the player U1 in order to display the composite image M3 on the display 13A based on a 35 display position on which the first captured image of the player U1, the second captured image of the second player U2, the first captured image and the second captured image are displayed respectively on the display 13A.

This enables each player to have an experience, for example, through a composite image displayed on the display 13 of each of the terminal apparatuses 10, in which the line of sight is corrected so that the line of sight of the other player is directed to the player's own position, as if the player were making eye contact over a mirror with the other player playing next to the player while each player is playing.

### Flow of Operations of Terminal Apparatus

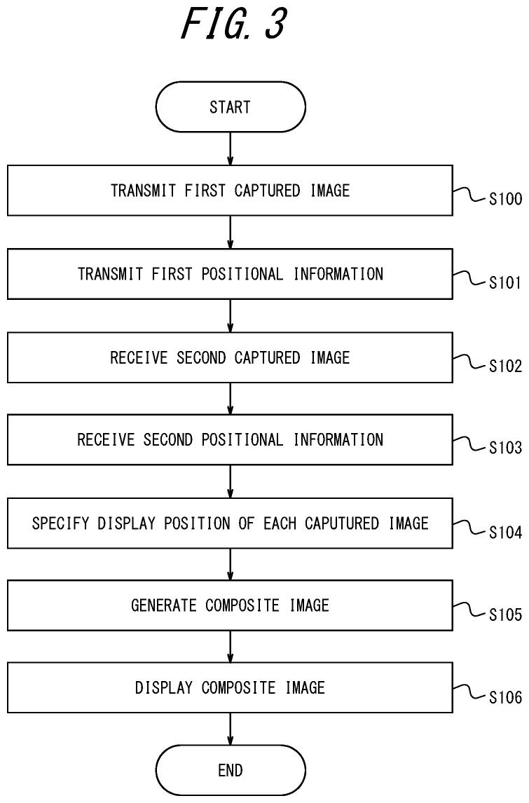

Operations of the terminal apparatus 10 according to the present embodiment will be described with reference to FIG. 3. The operations in FIG. 3 correspond to a method according to the present embodiment. These operations are, for example, initiated in response to the startup of the terminal apparatus 10 by the player who uses the terminal apparatus 10, but the conditions and/or timing for initiating these operations are not limited to the present example.

In the following, using a case illustrated in FIG. 2 as an example, a specific example of playing a remote duet in which the player U1 sits on the bass side (left side toward the keyboard 101) of the musical instrument 100A and the player U2 sits on the treble side (right side toward the keyboard 101) of the musical instrument 100B, sharing the range of notes, will be described. As described above, the player U1 corresponds to the “first player” in the present embodiment, and the player U2 corresponds to the “second player” in the present embodiment.

Step S100: The controller 18 of the terminal apparatus 10 transmits the captured image of the first player (hereinafter also referred to as a “first captured image”) to the separate terminal apparatus 10 via the communication interface 14.

Specifically, the controller 18 of the terminal apparatus 10 captures the image of the first player using the camera of the imager 11. The captured image of the first player acquired by capturing is a moving image consisting of multiple frames of images in the present embodiment. In the present embodiment, the controller 18 acquires moving images of the first player's finger movements by capturing images of the first player's hands as well as the front view of the first player. In the example illustrated in FIG. 2, the controller 18A of the terminal apparatus 10A captures the image of the player U1 using the camera of the imager 11A. The controller 18 then transmits the captured image of the first player to the communication interface 14 of the separate terminal apparatus 10 as the first captured image, via the network 20 and the communication interface 14.

In addition to the first captured image, the controller 18 may also convert the audio data received from the musical instrument 100 played by the first player via the audio input/output 16 into the electrical signal and acquire the electrical signal as the acoustic signal. The acoustic signal may be performance information, for example, Musical Instruments Digital Interface (MIDI) or the like. The controller 18 may collect sound of the musical instrument 100 played by the first player using the microphone of the audio input/output 16. The controller 18 may also collect the sound produced by the first player using the microphone of the audio input/output 16, convert the sound into the electrical signal, and acquire the electrical signal as an audio signal. The controller 18 can transmit the information acquired as above, such as the acoustic signal or the audio signal, together with the first captured image, to the separate terminal apparatus 10.

Step S101: The controller 18 transmits positional information indicating the position of the first player (hereinafter also referred to as a “first positional information”) to the separate terminal apparatus 10 via the communication interface 14.

In the present embodiment, the first positional information indicates the relative position of the first player using the terminal apparatus 10 with respect to the display 13. Specifically, the controller 18 of the terminal apparatus 10 derives the position of the first player based on the position of the display 13 of the terminal apparatus 10, by performing image analysis of the first captured image captured in step 5100. In this example, the display 13 of the terminal apparatus 10 is positioned on the top panel of the musical instrument 100 so that the display surface faces the first player, as illustrated in FIG. 2. In the example illustrated in FIG. 2, the player U1 is seated on the left side facing the keyboard 101A. Therefore, as viewed from the display 13A, the player U1 is located on the front right side of the display 13A. In this case, the controller 18A of the terminal apparatus 10A can derive the position of the right front side of the display 13A as the position of the player U1 from the first captured image. If the terminal apparatus 10 includes a sensor module capable of acquiring information on the distance and positional relationship, and the like between the subject (the player U1) and the display 13, the position may be derived using the information acquired by the sensor module. The controller 18 then transmits the positional information indicating the derived position of the first player to the communication interface 14 of the separate terminal apparatus 10 via the network 20 and the communication interface 14 as the first positional information.

Step S100 and Step S101 may be performed in parallel or in reverse order.

Step S102: The controller 18 receives the captured image of the second player (hereinafter also referred to as a “second captured image”) from the separate terminal apparatus 10 via the communication interface 14.

Specifically, the controller 18 of the separate terminal apparatus 10 captures an image of the second player using the camera of the imager 11. The captured image acquired by image capturing is the moving image consisting of multiple frame images, as described above in step 5100. The controller 18 of the separate terminal apparatus 10 transmits the captured image of the second player to the communication interface 14 of the terminal apparatus 10 as the second captured image, via the network 20 and the communication interface 14. In the example illustrated in FIG. 2, the controller 18B of the terminal apparatus 10B captures the image of the player U2 using the camera of the imager 11B. The controller 18B transmits a captured image of the player U2 to the terminal apparatus 10A as the second captured image. In this way, the controller 18 of the terminal apparatus 10 receives the second captured image from the separate terminal apparatus 10 via the communication interface 14. As described above in step S100, the controller 18 may also receive information such as the acoustic signal or the audio signal together with the second captured image from the separate terminal apparatus 10.

Step S103: The controller 18 receives positional information indicating the position of another player (hereinafter also referred to as a “second positional information”) from the separate terminal apparatus 10 via the communication interface 14.

In the present embodiment, the second positional information indicates the relative position of the second player and the display 13 of the separate terminal apparatus 10. Specifically, the controller 18 of the separate terminal apparatus 10 derives the position of the second player based on the position of the display 13B of the separate terminal apparatus 10 by analyzing the image of the second image captured in step S102. In this example, the display 13 of the separate terminal apparatus 10 is positioned in the same way as on the terminal apparatus 10 side, i.e., on the top panel of a separate musical instrument 100, with the display surface facing the second player. In the example illustrated in FIG. 2, the player U2 is seated on the right side facing a keyboard 101B. Therefore, as viewed from the display 13B, the player U2 is located on the left front side of display 13B. In this case, the controller 18B of the terminal apparatus 10B can derive the left front side of the display 13B as the position of the player U2 from the second captured image. The sensor module may be used to derive the relevant position as described above in step S101. The controller 18B transmits the positional information indicating the derived location of the player U2 to the terminal apparatus 10A as the second positional information. In this way, the controller 18 of the terminal apparatus 10 receives the second positional information from the separate terminal apparatus 10 via the communication interface 14.

Step S102 and Step S103 may be performed in parallel or in reverse

order. Although steps S100 through S103 are described as if they were executed sequentially, steps S100 through S103 can be executed in parallel or in any order.

Step S104: The controller 18 determines the display position of each of the first and second captured images on the display 13 based on the first and second positional information.

Specifically, the controller 18 determines which direction the first captured image (in this case, the first player's own figure) should be projected from the first player's perspective using the information on the relative positions of the first player and the display 13 of the terminal apparatus 10, as indicated by the first positional information. The controller 18 also determines which direction the second captured image (in this case, the second player's figure) should be projected from the first player's perspective using the information on the relative positions of the second player and the display 13 of the separate terminal apparatus 10, as indicated by the second positional information. For example, when displaying an image of oneself on the display 13, it is more natural to see the image as if it were a mirror, so the position of the first player is converted to the opposite left and right in the present embodiment (mirror inversion). The controller 18 determines the display position of each captured image on the display 13 based on each determined direction. Any method can be employed to determine the display position of each captured image, for example, it may be specified in pixel coordinates on the display 13. As a result, in this example, the first player's own figure (a first model for display described below) is projected on a predetermined area of the display surface of the display 13 in front of the first player by the composite image displayed on the display 13 in step 5106 described below. In addition, the second player's figure (a second model for display as described below) is projected on another predetermined area of the display surface of the display 13, which is located in front of the right side of the first player. As a result, it is easier to improve the reproducibility of the positional relationship between the players in the composite image described below, when one musical instrument (in this case, the plano) is played jointly by the first player and the second player.

Step S105: The controller 18 generates the composite image that includes the first player and the second player and in which the line of sight of the second player is directed to the position of the first player in order to display the composite image on the display 13 based on the first captured image of the first player, the second captured image of the second player, and the display position of the display 13.

Specifically, the controller 18 generates the composite image based on the relative position between the first player and the display 13 of the terminal apparatus 10, as indicated by the first positional information acquired in step S101, the relative position between the second player and the display 13 of the separate terminal apparatus 10, as indicated by the second positional information acquired in step 5103, and the display position on the display 13 of each captured image specified in step S104.

Any method can be employed to generate the composite image. For example, the controller 18 generates a model for display in which the first and second captured images are flipped horizontally (i.e., mirror-flipped). In the following, a model for display of the first captured image is also referred to as a “first model for display” and a model for display of the second captured image as a “second model for display. In the example illustrated in FIG. 2, a first model for display M1, which is a mirror-reversed image of the player U1, and a second model for display M2, which is a mirror-reversed image of the player U2, are generated. The controller 18 performs correction of the line of sight so that the line of sight of the second model for display (i.e., the mirror-reversed image of another player) is directed to the position of the first player derived from the first captured image, based on the relative positions of the first player and the display 13 derived in step S103. In the example illustrated in FIG. 2, the controller 18A of the terminal apparatus 10A can perform correction of the line of sight so that the line of sight of the second model for display M2 is directed to the position of the player U1 (here, the front right side of the display 13A). As the method of correcting the line of sight, a known method can be used. In other words, since the relative positions of the first player and the display 13 of the terminal apparatus 10 are identified from the first positional information in the present embodiment, the controller 18 can determine, based on the identified position, which direction the line of sight of the mirror-reversed image (the second model for display) of the second player generated from the second captured image which is displayed on a specified display position based on the second captured information should be directed.

The controller 18 can then generate the composite image that includes the first player, and the second player and in which the line of sight of the second player is directed to the position of the first player by combining the first model for display and the second model for display after correction of the line of sight. In the example illustrated in FIG. 2, the composite image M3 can be generated that includes the first model for display M1 and the second model for display M2 after correction of the line of sight and in which the line of sight of the mirror-reversed image of player U2 shown by the second model for display M2 is directed to the position of player U1.

Step S106: The controller 18 displays the composite image generated in step S105 on the display 13.

This enables the first player to have an experience as if the first player were visually recognizing over the mirror (i.e., the display surface of the display 13) the figure of the second player sitting next to the first player and playing while the player is playing. As a result, it is easier to improve the realistic feel of playing a remote duet.

In addition to this, when displaying the composite image on the display 13, the controller 18 of the terminal apparatus 10 may present to the first player a synthetic sound that is a combination of an acoustic signal from the first player's musical instrument performance (hereinafter also referred to as a “first acoustic signal”) and an acoustic signal from the second player's musical instrument performance (hereinafter also referred to as a “second acoustic signal”). The term “musical instrumental performance of the first player” refers to musical instrument performance of the musical instrument 100 by the first player. The term “musical instrumental performance of the second player” refers to musical instrument performance of the other musical instrument 100 by the second player. In this case, the controller 18 can transmit the first acoustic signal to the separate terminal apparatus 10 via the communication interface 14 and receive the second acoustic signal from the separate terminal apparatus 10. The synthetic sound can be presented to the first player, for example, by being output from the speaker of the audio input/output 16. If the musical instrument played by the first player is a musical instrument that produces performance sound (e.g., acoustic plano), only the second acoustic signal may be output from the speaker without using the synthetic sound. This enables the first player to listen to the performance as if the second player were sitting next to the first player and playing a duet on the musical instrument 100. As a result, it is easier to further improve the realistic feel of playing a remote duet.

In addition to this, the controller 18 of the terminal apparatus 10 may operate the musical instrument 100 of the first player in conjunction with the second captured image and the second acoustic signal. Specifically, the controller 18 may move a predetermined key on the keyboard 101 up and down, synchronizing the movement of the second model for display generated from the second captured image, based on the received performance information. This enables the first player to visually recognize the keyboard 101 of the musical instrument 100 in hand moving up and down in accordance with the performance by the synthetic sound (e.g., the dashed line 102 in FIG. 2) while visually recognizing the second model for display after line-of-sight correction. As a result, it is easier to further improve the realistic feel of playing a remote duet.

In addition to or instead of this, the terminal apparatus 10 may project the image of one or more hands with which the second player plays onto the musical instrument 100 of the first player using the projector 12. In the example illustrated in FIG. 2, the terminal apparatus 10A can project the image of one or more hands with which the player U2 plays onto the musical instrument 100A of the player U1 (e.g., at the position of the dashed line 102) using the projector 12A. As a result, it is easier to further improve the realistic feel of playing a duet.

The above description shows the case in which the system 1 includes one pair of terminal apparatuses 10, but the case in which the system 1 has three or more terminal apparatuses 10, i.e., the case in which there is a plurality of separate terminal apparatuses 10, is also included in the present embodiment. In the above description, the case in which each terminal apparatus 10 communicates via the network 20 is shown, but the case in which each terminal apparatus 10 communicates peer-to-peer is also included in the present embodiment.

As described above, the terminal apparatus 10 according to the present embodiment has the imager 11 configured to capture the image of the first player of the musical instrument and the controller 18 configured to generate the images to be displayed on the display 13. The terminal apparatus 10 further includes a communication interface 14 configured to communicate with a separate terminal apparatus 10 used by a second player. The controller 18 of the terminal apparatus 10 transmits a first captured image of the first player to the separate terminal apparatus 10 via the communication interface 14, and further generates a composite image that includes the first player and the second player and in which the line of sight of the second player is directed to the position of the first player in order to display the composite image on the display 13 based on the first captured image of the first player, a second captured image of the second player, and a display position of the display.

According to such a configuration, the composite image that includes the first player and the second player and in which the line of sight of the second user is directed to the position of the first user is generated. This enables the first player to have an experience through the composite image as if the first player were making eye contact over a mirror with the other player playing next to the first player by displaying the composite image on the display 13 of the terminal apparatus 10 while the first player is playing, for example. As a result, it is easier to improve the realistic feel of playing a duet.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

1. A terminal apparatus comprising:
an imager configured to capture an image of a first user;
a controller configured to generate an image to be displayed on a display; and
a communication interface configured to communicate with a separate terminal apparatus used by a second user,
wherein the controller is configured to:
transmit a first captured image of the first user to the separate terminal apparatus via the communication interface; and
generate a composite image that includes the first user and the second user and in which a line of sight of the second user is directed to a position of the first user in order to display the composite image on the display based on the first captured image, a second captured image of the second user, and a display position of the display.

2. The terminal apparatus according to claim 1, wherein the first user is a first player of a musical instrument and the second user is a second player.

3. The terminal apparatus according to claim 2, wherein the controller is configured to:
transmit a first acoustic signal by musical instrumental performance of the first player to the separate terminal apparatus via the communication interface;
generate synthetic sound in which the first acoustic signal and a second acoustic signal by musical instrumental performance of the second player are synthesized; and
present the synthetic sound to the first player when the composite image is displayed on the display.

4. The terminal apparatus according to claim 3, wherein the controller is configured to operate the musical instrument of the first player in conjunction with the second captured image and the second acoustic signal.

5. The terminal apparatus according to claim 2, further comprising a projector,
wherein the controller is configured to project an image of one or more hands with which the second player plays onto the musical instrument of the first player using the projector.

6. The terminal apparatus according to claim 2, wherein the musical instrument is such a musical instrument that one musical instrument is played jointly by the first player and the second player.

7. A control method for a system that includes a terminal apparatus and a separate terminal apparatus, the terminal apparatus having an imager configured to capture an image of a first user and a controller configured to generate an image to be displayed on a display, the separate terminal apparatus being used by a second user and communicating with the terminal apparatus, the control method comprising:
transmitting, by the controller, a first captured image of the first user to the separate terminal apparatus via a communication interface;
displaying on the display, by the controller, an image that includes the first user and the second user and in which a line of sight of the second user is directed to a position of the first user based on the first captured image, a second captured image of the second user, and a di splay position of the display.

8. A non-transitory computer readable medium storing a program configured to cause a computer to execute the control method according to claim 7.
